(19) United States
(12) Patent Application Publication
(10) Pub. No.: US 2014/0118223 A1
(43) Pub. Date: May 1, 2014

(54) GRAPHICAL VIEW SELECTION SYSTEM, METHOD, AND APPARATUS

(71) Applicant: Brigham Young University, Provo, UT (US)

(72) Inventors: Charles Gregory Jensen, Provo, UT (US); Thomas Trevor Nysetvold, The Woodlands, TX (US); Chia-Chi Teng, Provo, UT (US); Ammon Hepworth, Provo, UT (US); Brett Stone, Lehi, UT (US); Philip Cox, Austin, TX (US)

(73) Assignee: Brigham Young University, Provo, UT (US)

(21) Appl. No.: 14/063,997

(22) Filed: Oct. 25, 2013

Related U.S. Application Data
(60) Provisional application No. 61/718,874, filed on Oct. 26, 2012.
(60) Provisional application No. 61/745,660, filed on Dec. 24, 2012.

(51) Int. Cl. G06F 3/14; G06T 19/20

(52) U.S. Cl. CPC G06F 3/1454; G06T 19/20
USPC 345/2.2

(57) ABSTRACT

A method for selecting a view of a graphical rendering of an object may include (1) rendering an object according to a first view on a first display corresponding to a first user, (2) receiving information regarding a second view of the object on a second display corresponding to a second user, (3) displaying an interface element corresponding to the second view on the first display, (4) rendering the second view of the object on the first display in response to selection of the interface element corresponding to the second view. Various other systems, apparatus, and computer-readable media corresponding to the above method are also disclosed herein.

### REFERENCE TO RELATED APPLICATIONS

The present application is related to, and claims the benefit of priority of, U.S. Provisional Application 61/718,874, entitled “CAD View Transfer System,” filed on 26 Oct. 2012, and to U.S. Provisional Application 61/745,660, entitled “Multi-User CAD,” and filed on 24 Dec. 2012. The entire content of each of the foregoing applications is incorporated herein by reference.

### BACKGROUND OF THE INVENTION

1. Field of the Invention

The claimed invention relates to computer aided technologies (CAx) such as computer aided design, engineering, analysis and manufacture in general and apparatus, systems, means, and methods for graphical view selection in particular.

2. Description of the Related Art

Large design and engineering projects have always required coordination between several designers or engineers, typically divided into teams. Even small projects may include a team of designers, whether physically located together or organized as a virtual team. CAx applications have not always provided adequately for the coordination of work between members of a team. The needs of team leaders, trainers, mentors, design reviewers, and process observers provide additional challenges, as does the need to conduct group design reviews.

Accordingly, the present invention generally relates to systems, apparatus, and methods for graphical view selection.

### BRIEF SUMMARY OF THE INVENTION

The present invention has been developed in response to the present state of the art, and in particular, in response to the problems and needs in the art that have not yet been fully solved by currently available graphical view selection systems, apparatus, and methods. Accordingly, the claimed inventions have been developed to provide a graphical view selection apparatus, method, and system that overcome shortcomings in the art.

As detailed herein, a method for graphical view selection may include (1) rendering an object according to a first view on a first display corresponding to a first user, (2) receiving information regarding a second view of the object on a second display corresponding to a second user, (3) displaying an interface element corresponding to the second view on the first display, (4) rendering the second view of the object on the first display in response to selection of the interface element corresponding to the second view.

In one embodiment, the method may include enabling the first user to edit the object according to the second view. In one example, the interface element may depict an orientation of the second view. In another example, the interface element may be displayed proximate to the rendering of the object according to the first view.

In some embodiments, the information regarding the second view may include (1) extent information, (2) origin information, (3) scaling information, (4) frustum information; and (5) transformation information. In one example, information regarding the second view may include the visibility and/or selection status of features or objects within the second view. In other examples, the second view may be any regular, isometric, pictorial, section, cutaway, or partial view.

In one embodiment, the method may include repeatedly updating the second view on the first display. In one example, rendering the second view of the object on the first display may include indicating portions of the object that a particular user is editing. In one embodiment, the method may include rendering the object according to a plurality of user views in a corresponding plurality of windows. In another embodiment, the method may include displaying an activity synopsis for the second user proximate to the interface element. In another embodiment, the method may include warning the first or second user when the first or second user and another user are attempting proximate edits.

In one embodiment, various elements of the present invention are combined into a system for graphical view selection that may include (1) a rendering module that renders an object according to a first view on a first display corresponding to a first user (2) a view receiving module that receives information regarding a second view of the object on a second display corresponding to a second user, (3) a display module that displays an interface element corresponding to the second view on the first display, (4) the rendering module also rendering the second view of the object on the first display in response to selection of the interface element corresponding to the second view, and (5) at least one processor configured to execute the rendering module, the view receiving module, and the display module.

In some examples, the above-described method may be encoded as computer-readable instructions on a computer-readable-storage medium. For example, a computer-readable-storage medium may include one or more computer-executable instructions that, when executed by at least one processor of a computing device, may cause the computing device to (1) render an object according to a first view on a first display corresponding to a first user, (2) receive information regarding a second view of the object on a second display corresponding to a second user, (3) display an interface element corresponding to the second view on the first display, and (4) render the second view of the object on the first display in response to selection of the interface element corresponding to the second view.

It should be noted that references throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram of one example of a computing and communications infrastructure that is consistent with one or more embodiments of the claimed invention;

FIG. 2 is a block diagram of one example of a graphical view selection system that is consistent with one or more embodiments of the claimed invention;

FIG. 3 is a flowchart diagram illustrating one embodiment of a graphical view selection method of the claimed invention;

FIG. 4 is a perspective view illustration depicting one example of a viewing frustum that is consistent with one or more embodiments of the claimed invention;

FIG. 5 is a graphical and text diagram illustrating one example of a graphical view selection user interface that is consistent with one or more embodiments of the claimed invention;

FIG. 6 is a graphical and text diagram illustrating another example of a graphical view selection user interface that is consistent with one or more embodiments of the claimed invention; and

FIG. 7 is a graphical and text diagram illustrating one example of a graphical view selection user interface that is consistent with one or more embodiments of the claimed invention.

### DETAILED DESCRIPTION OF THE INVENTION

Some of the functional units described in this specification have been labeled as modules, in order to more particularly emphasize their implementation independence. Others are assumed to be modules. For example, a module or similar unit of functionality may be implemented as a hardware circuit comprising custom VLSI circuits or gate arrays, off-the-shelf semiconductors such as logic chips, transistors, or other discrete components. A module may also be implemented with programmable hardware devices such as field programmable gate arrays, programmable array logic, programmable logic devices or the like.

A module or a set of modules may also be implemented (in whole or in part) as a processor configured with software to perform the specified functionality. An identified module may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, the executable code of a module may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any tangible form capable of enabling execution of a program of machine-readable instructions on a digital processing apparatus. For example, a computer readable medium may be embodied by a flash drive, compact disk, digital-video disk, a magnetic tape, a Bernoulli drive, a magnetic disk, a punch card, flash memory, integrated circuits, or other digital processing apparatus memory device. A digital processing apparatus such as a computer may store program codes, associated data, and the like on the computer readable medium that when retrieved enable the digital processing apparatus to execute the functionality specified by the modules.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

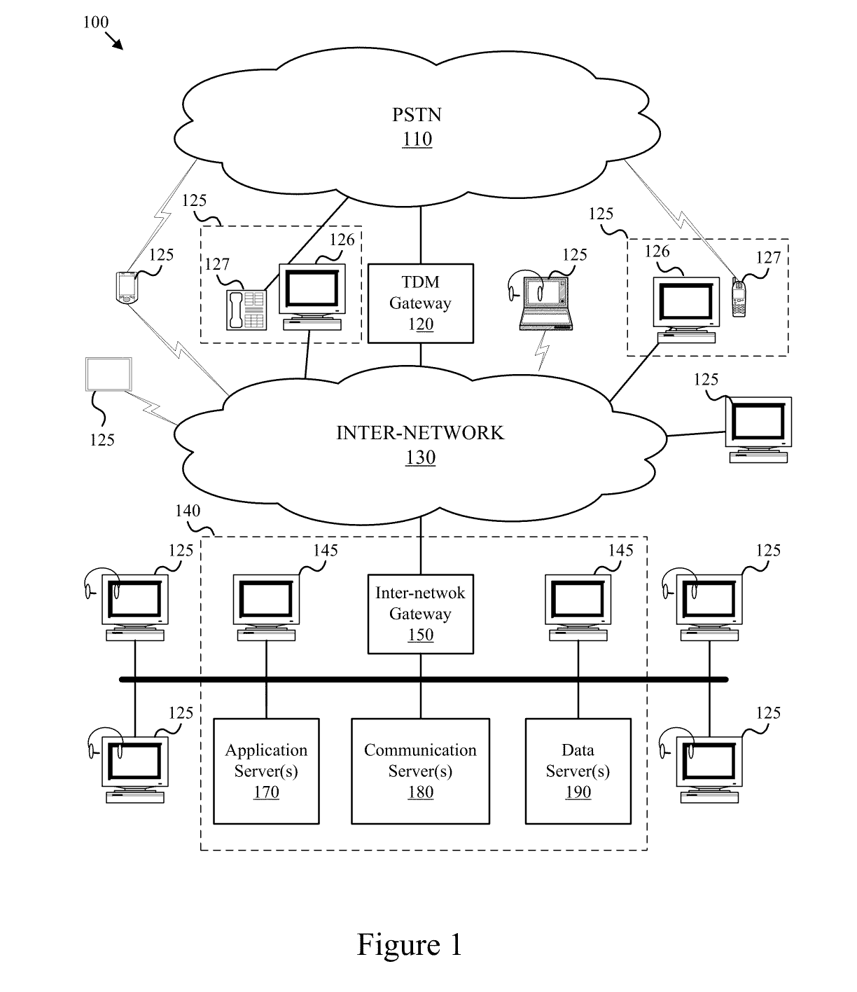

FIG. 1 is a block diagram of one example of a computing and communications infrastructure 100 that is consistent with one or more embodiments of the claimed invention. As depicted, the infrastructure 100 includes various systems, subsystems, and networks such as a public switched telephone network (PSTN) 110, a TDM gateway 120 connecting the PSTN to an inter-network 130, a variety of workstations 125, a data center 140 with administrative terminals 145, an inter-network gateway 150 connecting a local area network to the inter-network 130, and various servers such as application servers 170, communication servers 180, and data servers 190. The infrastructure 100 is one example of components that can be operably interconnected to provide an infrastructure for a computer-aided design, computer-aided engineering, or computer-aided manufacturing (CAx) system that includes a graphical view selection system.

Each workstation 125 may include a separate computing device 126 and a communications device 127 or the computing device and communications device may integrated into the workstation 125. Examples of the communications device 127 include a phone, a VOIP device, an instant messaging device, a texting device, a browsing device, and the like. The computing devices 126 may enable graphical view selection. The communications devices 127 may enable users to communicate with other CAx system users.

The inter-network 130 may facilitate electronic communications between the various workstations and servers. In one embodiment, the inter-network 130 is the internet. In another embodiment, the inter-network 130 is a virtual private network (VPN).

Various servers such as blade servers within the data center 140 function cooperatively to facilitate concurrent collaborative editing of CAx models by local and remote users. For example, the application servers 170 may provide one or more CAx applications to the local and remote users. Some users may have the CAx applications installed on their local computing devices 126. Examples of CAx applications include Siemens NX, MSC Nastran, Dessault Systems CATIA and Solidworks, ANSYS, and the like.

The communication servers 180 may facilitate communications between the users through various channels or services such as VOIP services, email services, instant messaging services, short message services, and text messaging services. The workstations 125 may leverage such services for user to user communications via the communication servers 180 or via other available service platforms.

The data servers 190 or the like may store CAx models within various model files or records. The data servers may replicate copies of the models for use by various users. Some users may have a local copy of a model. As described herein, instead of requiring a particular user to assume control of a model file or record, updates to the model may be coordinated by one or more CAx applications including client versions, server versions, and cloud versions of such applications.

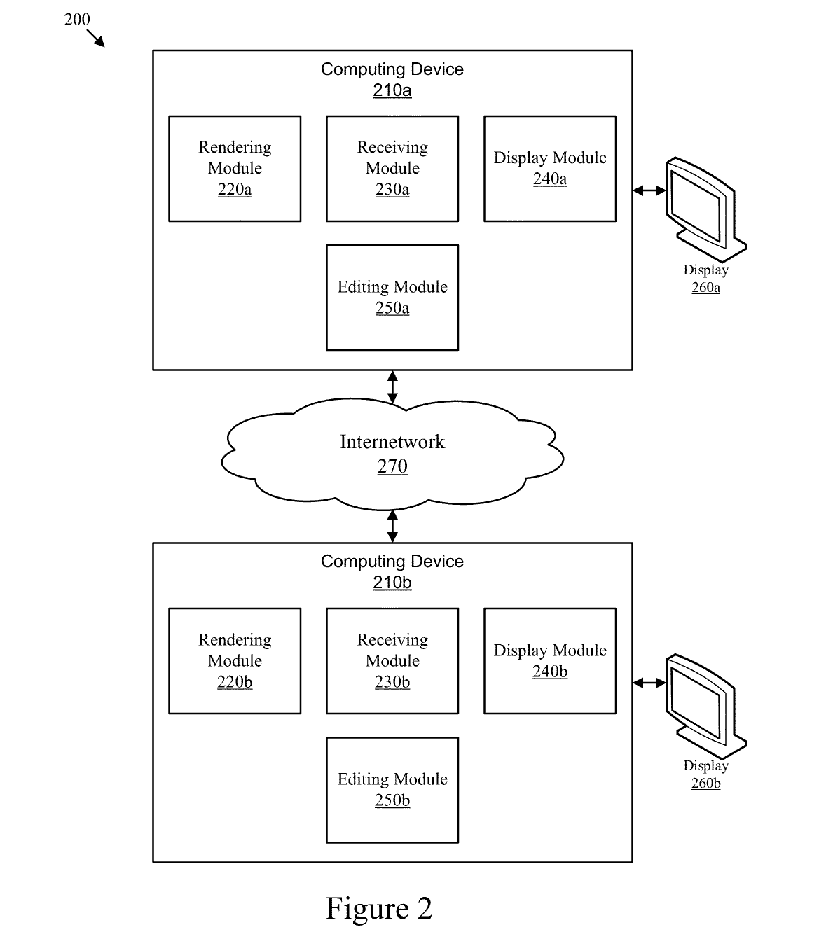

FIG. 2 is a block diagram of one example of a graphical selection system 200 that is consistent with one or more embodiments of the claimed invention. As depicted, the graphical selection system 200 includes one or more computing devices 210 that may include a variety of modules distributed therein, including rendering modules 220, view receiving modules 230, display modules 240, and editing modules 250. Each of the modules may reside on a single computing device 210 (i.e. node) or be collaboratively partitioned onto multiple devices or nodes, with at least one computing device 210 connected to a graphical display 260. The modules may be primarily or wholly comprised of software codes and associated data that are executed and processed by a digital processing apparatus such as a computer to provide the specified functionality. Computing devices 210 may communicate via an internetwork 270, such as the Internet or a virtual private network (VPN).

As illustrated in FIG. 2, as part of graphical selection system 200, the computing devices 210 may include one or more modules for performing one or more tasks. For example, and as will be described in greater detail below, exemplary system 200 may include a rendering module 220 that may be programmed to render an object according to a first view on a first display corresponding to a first user. View receiving module 230 may be programmed to receive information regarding a second view of the object on a second display corresponding to a second user.

In addition, and as will be described in greater detail below, display module(s) 240 may be programmed to display an interface element corresponding to the second view on the first display. Rendering module(s) 220 may be programmed to render the second view of the object on the first display in response to selection of the interface element corresponding to the second view. In some examples, computing device(s) 210 may include editing module(s) 250 that enables the first user to edit the object according to the second view. In one embodiment, graphical selection system 200 may be implemented as a plug-in to a CAx application, utilizing an interface provided by the CAx application.

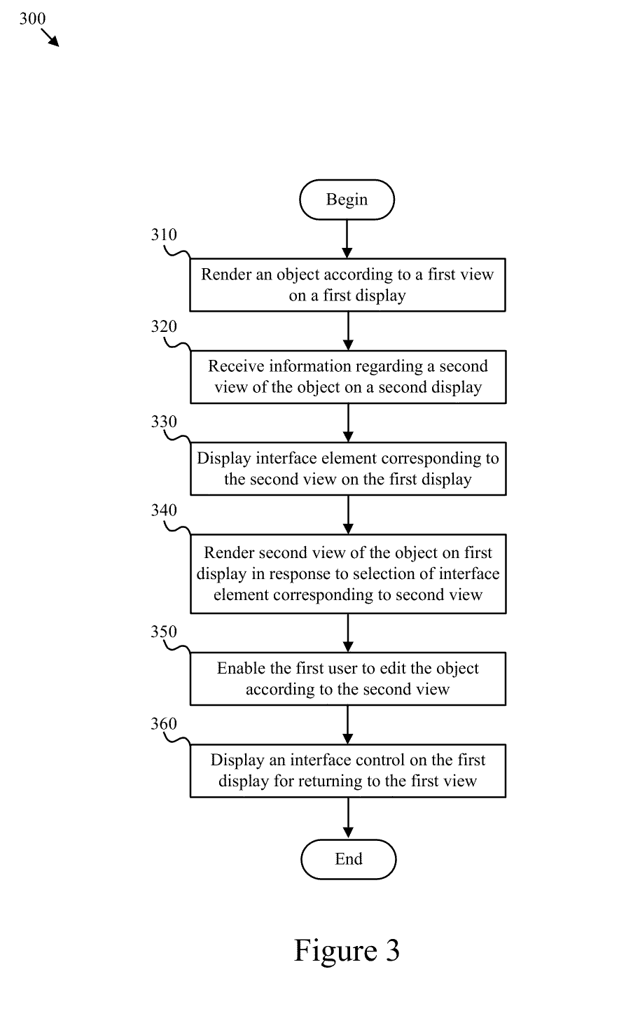

As illustrated in FIG. 3, at step 310 one or more of the systems described herein may render an object according to a first view on a first display corresponding to a first user. For example, at step 310 rendering module 220 may, as part of computing device 210 in FIG. 2, render an object according to a first view on a first display corresponding to a first user.

The term “rendering,” as used herein, generally refers to the process of generating an image from a model by means of executing instructions. The model defines objects in a strictly defined language or data structures. Rendering the model typically involves creating a two-dimensional representation of a three-dimensional object from a selected viewpoint, and considering perspective, scale, and orientation.

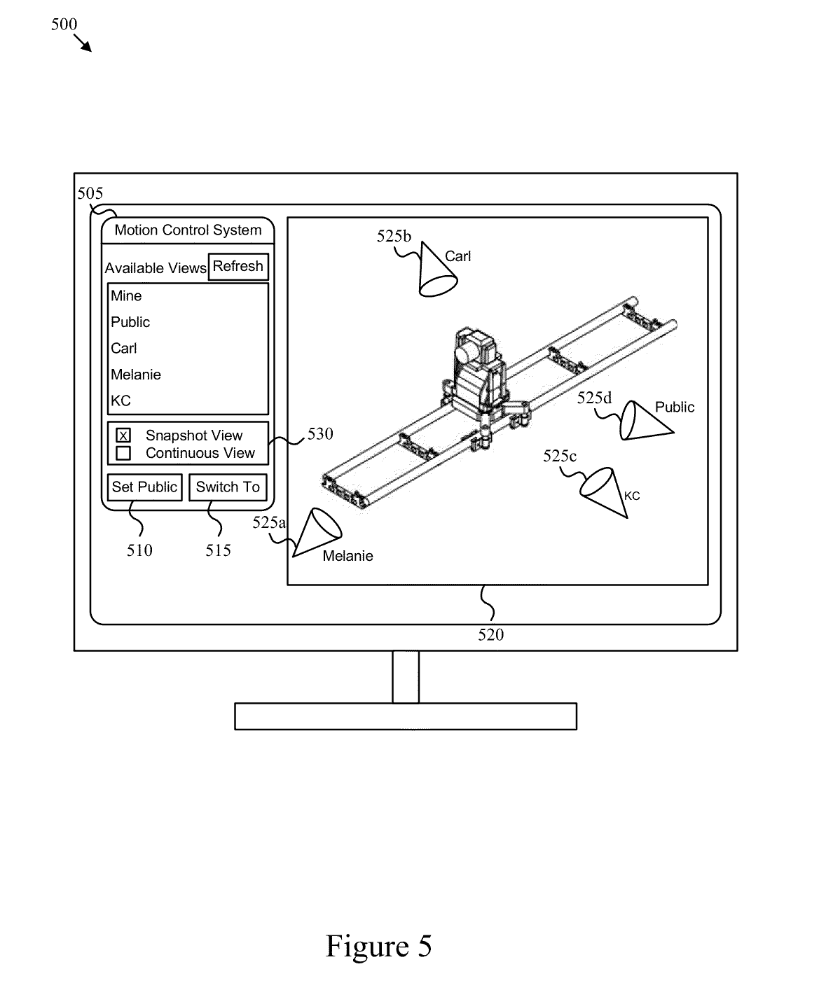

FIG. 5 is a graphical and text diagram illustrating one example of a graphical view selection user interface 500 that is consistent with one or more embodiments of the claimed invention and suitable for rendering images of design objects. As depicted in FIG. 5, the graphical view selection user interface 500 may include a view selection interface element 505 and a current view 520. The view selection interface element 505 may further include a set public control 510 that sets the current view 520 as a public view that other CAx application users may select. The view selection interface element 505 may also include a view selection control 515 and a view mode control 530. The current view 520 may further include user view frustum icons 525 representing the perspective and scope of current views of other CAx application users.

Returning to FIG. 3, at step 310, rendering module 220 may, as part of computing device 210 in FIG. 2, render an object in current view 520 according to the view of the user of the graphical view selection user interface 500 on a first display. At step 320 one or more of the systems described herein may receive information regarding a second view of the object on a second display corresponding to a second user. For example, at step 320 view receiving module 230 may, as part of computing device 210 in FIG. 2, receive information regarding a second view of the object on a second display corresponding to a second user.

The graphical view selection system 200 may receive information regarding a second view of the object on a second display corresponding to a second user in any manner suitable to identifying and displaying the second view of the object. For example, view receiving module 230 may receive extent information, origin information, scaling information, frustum information, cursor information, and transformation information corresponding to the current view 520 of a second user of the graphical view selection user interface 500 on a second display, as depicted in FIG. 5. In one embodiment, information regarding the second view includes the visibility of features or objects within the second view. The information regarding the second view may include cutaway view information, show/hide setting information, cursor position information, selection information, and dialog box information. The information may enable the first user to have the same view as the second user of the object. In one embodiment, all of the available information of the second users view is reflected in the first users view. The graphical view selection system 200 enables the first user to assume the view of the second user without the first or second user giving up control to the other user.

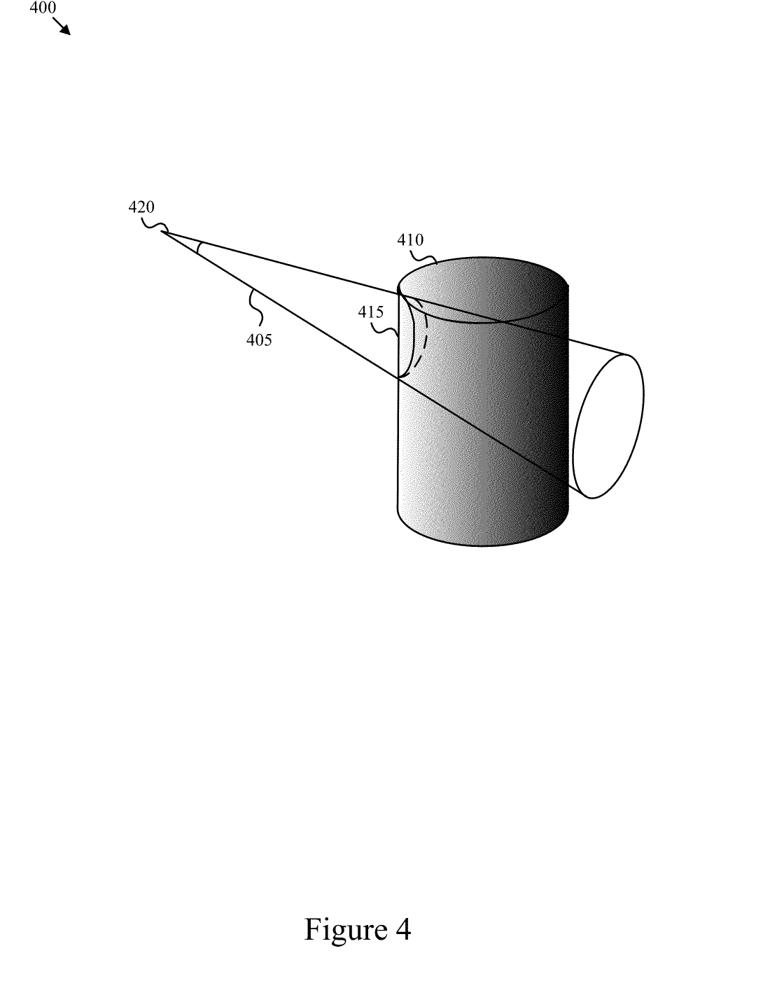

As used herein, the term “frustum” generally refers to the region of an object that is visible to a designer on a computer screen. Although sometimes depicted as a square or rectangular pyramid, a viewing frustum is represented herein as a circular cone, as shown in FIG. 4.

FIG. 4 is a perspective view illustration depicting one example of a viewing frustum 400 that is consistent with one or more embodiments of the claimed invention. As depicted in FIG. 4, a viewing frustum 405 transects a viewed object 410. Surface area 415 represents the area of object 410 visible to a second user on a second display, as defined by frustum 405. Rather than portray the entire visual frustum, the orientation and scope of the frustum may be represented iconically by a small section 420 of the frustum cone at the apex.

Returning to FIG. 3, at step 330 one or more of the systems described herein may display an interface element corresponding to the second view on the first display. For example, at step 330 display module 240 may, as part of computing device 210 in FIG. 2, display an interface element corresponding to the second view on the first display. Display module 240 shown in FIG. 2 may, as depicted in FIG. 5, display a user view frustum icon 525 in current view 520 corresponding to the second view of the object on a second display. The second view of the object may correspond to a second CAx application user. For example, as depicted in FIG. 5, display module 240 may display user view frustum icon 525a indicating that CAx application user Melanie is currently viewing an end view of the design object. In another example, display module 240 may display user view frustum icon 525d indicating that the most recent public view of the design object, selected by activating the set public user control 510, is a side view of the design object.

Graphical selection user interface 500 may display an interface element corresponding to the second view on the first display in any suitable manner. In one example, display module 240 may display a user view frustum icon 525 in current view 520 depicting an orientation of the second view. In another example, display module 240 may display a user view frustum icon 525 in current view 520 corresponding to the second view of the object on a second display corresponding to a second CAx application user proximate to the rendering of the object according to the first view.

Returning to FIG. 3, at step 340 one or more of the systems described herein may render the second view of the object on the first display in response to selection of the interface element corresponding to the second view. For example, at step 340 rendering module 220 may, as part of computing device 210 in FIG. 2, render the second view of the object on the first display in response to selection of the interface element corresponding to the second view without the first user giving up control to the second user.

Graphical selection user interface 500 may render the second view of the object on the first display in response to selection of the interface element corresponding to the second view in various ways. In one example, rendering module 220 may suspend frustum viewing and rendering of the design object according to the first view and replace it with a rendered view of a second frustum view and render state according to a selected second view.

In one example, rendering module 220 may render the second view of the object in current view 520 in of graphical selection user interface 500, as depicted in FIG. 5, in response to the user selecting the name of the second user in view selection interface element 505 and activating view selection control 515. In another example, rendering module 220 may render the second view of the object in current view 520 in response to the user of the graphical selection user interface 500 selecting and activating a user view frustum icon 525. For example, the user may position the mouse cursor over user view frustum icon 525b and double-click the left mouse button to select the second view corresponding to user Carl to be rendered in current view 520. In one embodiment, the second view may be a cutaway view.

In one embodiment, graphical selection user interface 500 may repeatedly update the second view on the first display. For example, view receiving module 230 may repeatedly receive information regarding the second view of the object on a second display, and rendering module 220 may repeatedly render the second view of the object on the first display. In one example, as depicted in FIG. 5, view selection interface element 505 may include a view mode control 530 that enables the user of the graphical selection user interface 500 to select whether to render the second view in an instantaneous or “snapshot mode” or to repeatedly update the second view in a “continuous mode” to correspond to the first view. In one embodiment, rendering module 220 interpolates between updates of the second view information to provide a smooth transition to the new view.

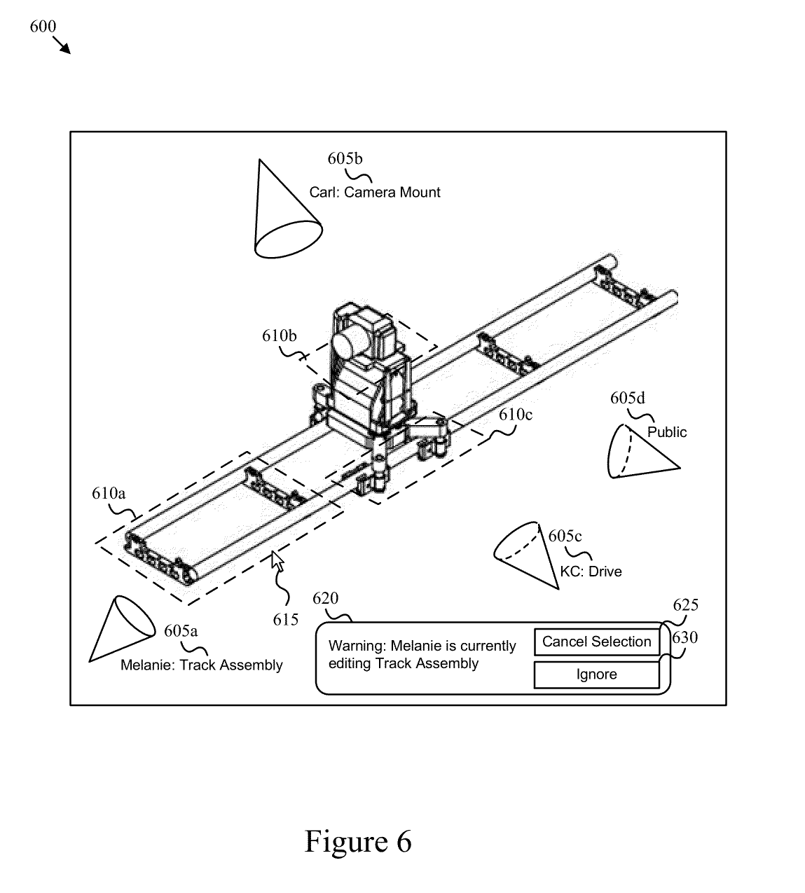

In another embodiment, rendering the second view of the object on the first display may include indicating portions of the object that a particular user is editing. FIG. 6 is a graphical and text diagram illustrating an example of a graphical view selection user interface 600 that is consistent with one or more embodiments of the present invention. Graphical view selection interface 600 may include user view icons 605, and user editing selection regions 610. Similar to the user view frustum icons 525 depicted in FIG. 5, user view icons 605 may include an iconic frustum cone indicating the scope and perspective of the design object for a second CAx application user. User editing selection regions 610 may indicate parts of the design object currently selected for editing by a second user corresponding to a user view icon 605. For example, as depicted in FIG. 6, user editing selection region 610c may indicate the parts of the design object currently selected for editing by user KC, corresponding to user view icon 605c.

Graphical view selection interface 600 may indicate portions of the design object that a particular user is editing in a variety of ways. As depicted in FIG. 6, the portion of the design object selected for editing may be indicated with a box surrounding the area selected for editing. In other embodiments, the portion of the design object selected for editing may be indicated using shading, color, patterns, or highlighting, either of the parts of the design object selected for editing or the surrounding area.

In one embodiment, one or more of the systems described herein may display an activity synopsis for the second user proximate to the interface element. For example, as depicted in FIG. 6, graphical view selection interface 600 may include an activity synopsis as part of user view icon 605. For example, user view icon 605b includes an activity synopsis for user Carl proximate to the iconic viewing frustum, indicating that the user has selected the camera mount for editing.

Returning to FIG. 3, at step 350 one or more of the systems described herein may enable the first user to edit the object according to the second view. For example, at step 350 editing module 250 may, as part of computing device 210 in FIG. 2, enable the first user to edit the object according to the second view.

One or more of the systems described herein may enable the first user to edit the object according to the second view in various ways. For example, editing module 250 may enable the first user to highlight, mark-up, annotate the design object, and/or create and modify features of the design object according to the second view.

In one embodiment, graphical user interface 500 may constrain which of the available views may be selected for viewing or editing. For example, members of a design team may have defined roles with associated privileges for selecting and editing alternate views. A member of a design team may be permitted only to select a view designated as a public view, or each team member may be permitted to view any other user view, but not to edit. A user in a supervisor role may be permitted to view or edit any user view. A user in a trainer or mentor role may be permitted to view or edit only views of users designated as student designers.

In one embodiment, one or more of the systems described herein may warn the first or second user when the user and another user are attempting proximate edits. For example, as depicted in FIG. 6, graphical view selection interface 600 may include a mouse cursor 615 to facilitate selection and editing of portions of the design object, as well as a warning dialog 620 that warns the user of potential editing conflicts. Warning dialog 620 may further include a cancel selection control 625 and an ignore control 630. If the first user attempts to select the track assembly for editing using mouse cursor 615, editing module 250 may display warning dialog 620, indicating that user Melanie has already selected the track assembly for editing, as indicated in the activity synopsis displayed as part of user view icon 605a. The first user may cancel selection of the track assembly by activating cancel selection control 625, or ignore the warning and continue selection and editing of the track assembly by activating ignore control 630.

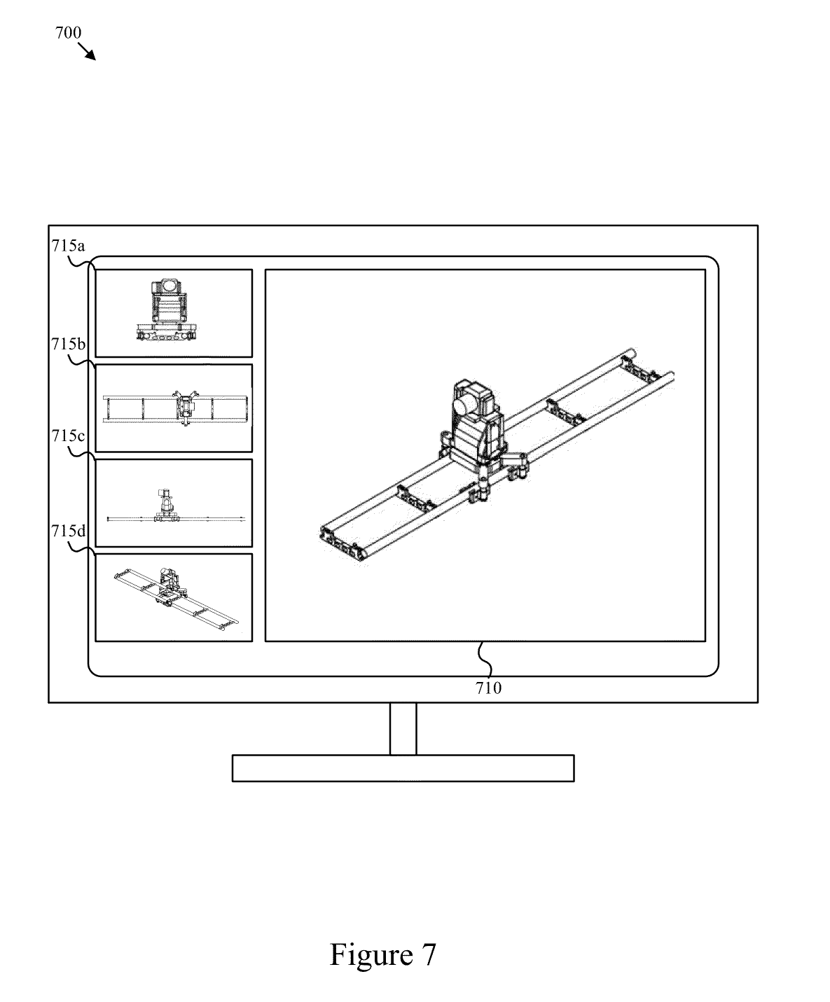

In one embodiment, on or more of the systems described herein may render the design object according to a plurality of user views in a corresponding plurality of windows. FIG. 7 is a graphical and text diagram illustrating one example of a graphical view selection user interface 700 that is consistent with one or more embodiments of the present invention. As depicted in FIG. 7, graphical view selection user interface 700 may include a current view 710 and alternate user views 715 representing current views 710 as seen by other CAx application users. In one example, a user of graphical view selection user interface 700 may select an alternate user view 715 by positioning a mouse cursor over the alternate user view 715 to be selected and double-clicking the left mouse button. The selected alternate user view 715 may then be rendered in current view 710. In one embodiment, graphical view selection user interface 700 includes a user interface control that, when activated, returns the user to the original view.

Returning to FIG. 3, at step 360 one or more of the systems described herein may display an interface control on the first display for returning to the first view. In one example, display module 240 as part of computing device 210 may, as depicted in FIG. 5, display a user view labeled “Mine” in the list of available views in view selection interface element 505. The user may return to the first view by selecting the user view labeled “Mine” and activating view selection control 515. In another example, a user interface control labeled “Return to My View” may be included in view selection interface element 505. The user may return to the first view by activating the “Return to My View” user interface control. Upon activation of the interface control, the display may return to the first frustum view and rendering state.

The graphical view selection system, apparatus, and method described herein facilitate various collaborative design activities. For example, members of a team of designers can use the graphical view selection system to determine which portions of a design object another user is editing to coordinate team design activities and avoid editing conflicts. A supervisor may graphical view selection user interface 700 to monitor and coordinate design activities between members of a design team. A design “checker” may likewise use graphical view selection user interface 700 to select graphical design views of various users to verify technical design aspects or adherence to design standards. A mentor or trainer may use a continuous mode graphical view to demonstrate design techniques or to observe design activities of a design student. Group design reviews may be facilitated by the designer conducting the design review selecting a public view that may be selected by other designers participating in the design review.

The various elements of the graphical view selection system and apparatus function cooperatively to facilitate productive collaborative design using CAx applications. The preceding depiction of the graphical view selection systems, apparatus, and methods, in addition to other inventive elements described herein are intended to be illustrative rather than definitive. Similarly, the claimed invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for selecting a view of a graphical rendering of an object, the method comprising:
rendering an object according to a first view on a first display corresponding to a first user;
receiving information regarding a second view of the object on a second display corresponding to a second user;
displaying an interface element corresponding to the second view on the first display;
rendering the second view of the object on the first display in response to selection of the interface element corresponding to the second view.

2. The method of claim 1, further comprising enabling the first user to edit the object according to the second view.

3. The method of claim 1, wherein the interface element depicts an orientation of the second view.

4. The method of claim 3, wherein the interface element is displayed proximate to the rendering of the object according to the first view.

5. The method of claim 1, further comprising displaying an interface control on the first display for returning to the first view.

6. The method of claim 1, wherein the information regarding the second view comprises at least one of:
extent information;
origin information;
scaling information;
cursor information;
frustum information; and
transformation information.

7. The method of claim 1, wherein the information regarding the second view comprises the visibility of features or objects within the second view.

8. The method of claim 1, wherein the second view is a cutaway view.

9. The method of claim 1, further comprising repeatedly updating the second view on the first display.

10. The method of claim 1, wherein rendering the second view of the object on the first display comprises indicating portions of the object that a particular user is editing.

11. The method of claim 1, further comprising rendering the object according to a plurality of user views in a corresponding plurality of windows.

12. The method of claim 1, further comprising displaying an activity synopsis for the second user proximate to the interface element.

13. The method of claim 1, further comprising warning the first or second user when the first or second user and another user are attempting proximate edits.

14. A system for selecting a view of a graphical rendering of an object, the system comprising
a rendering module that renders an object according to a first view on a first display corresponding to a first user;
a view receiving module that receives information regarding a second view of the object on a second display corresponding to a second user;
a display module that displays an interface element corresponding to the second view on the first display;
the rendering module further configured to render the second view of the object on the first display in response to selection of the interface element corresponding to the second view;
at least one processor configured to execute the rendering module, the view receiving module, and the display module.

15. The system of claim 14, further comprising an editing module configured to enable the first user to edit the object according to the second view.

16. The system of claim 14, wherein the display module is further configured to display an interface control on the first display for returning to the first view.

17. The system of claim 14, wherein the rendering module is further configured to repeatedly update the second view on the first display.

18. The system of claim 14, wherein the rendering module is further configured to render the second view of the object on the first display, indicating portions of the object that a particular user is editing.

19. The system of claim 14, wherein the rendering module is further configured to render the object according to a plurality of user views in a corresponding plurality of windows.

20. A non-transitory computer-readable medium comprising one or more computer-executable instructions that, when executed by at least one processor of a computing device, cause the computing device to:
render an object according to a first view on a first display corresponding to a first user;
receive information regarding a second view of the object on a second display corresponding to a second user;
display an interface element corresponding to the second view on the first display;
display the second view of the object on the first display in response to selection of the interface element corresponding to the second view.
